(19) United States
(12) Patent Application Publication
(10) Pub. No.: US 2005/0268172 A1
(43) Pub. Date: Dec. 1, 2005

(54) System, apparatus, method and program for evaluating usability to content

(75) Inventors: Nozomi Uchinomiya, Yokohama (JP); Katsumi Kawai, Yokohama (JP); Yoshinobu Uchida, Yokohama (JP); Ryota Mibe, Sagamihara (JP); Chiaki Hirai, Tokyo (JP); Keiji Minamitanti, Kawasaki (JP); Takahiro Inada, Musashino (JP); Jun Shijo, Kawasaki (JP); Takafumi Kawasaki, Machida (JP); Kaori Kashimura, Tokyo (JP); Yuuki Hara, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/100,078

(22) Filed: Apr. 5, 2005

(30) Foreign Application Priority Data
Apr. 5, 2004 (JP) 2004-111139

(51) Int. Cl. G06F 11/00

(52) U.S. Cl. 714/37

(57) ABSTRACT

In the present invention, a first information processing apparatus displays a window for the content on a display device depending on operations to an input device; the first information processing apparatus obtains feedback operation logs including assessment information for the window and date-time information when the assessment information has been input; the first information processing apparatus obtains operation logs including operation information to the input device and date-time information when the operation has been input; the first information processing apparatus obtains communication logs including date-time information when the window has been displayed and information for identifying the window; the first information processing apparatus sends to a second information processing apparatus the feedback operation logs, the operation logs and the communication logs; the second information processing apparatus receives from the first information processing apparatus the feedback operation logs, the operation logs and the communication logs; the second information processing apparatus correlates information included in at least two of the feedback operation logs, the operation logs and the communication logs in chronological order based on the date-time information included in each log; and usability assessment information is thus generated for the content.

### CROSS-REFERENCE TO RELATED APPLICATIONS

The present application claims priority upon Japanese Patent Application No. 2004-111139 filed on Apr. 5, 2004, which is herein incorporated by reference.

### BACKGROUND OF THE INVENTION

1. Field of the Invention

The present invention relates to a system, apparatus, method and program for evaluating usability to content.

2. Description of the Related Art

Recently, various types of information are distributed via the Internet and many companies compete fiercely for improving the quality of the web services to increase access rates or to acquire customers. Usability, i.e. an ease of use of a system is an important factor having influence on the quality of the web services. No matter how excellent the content provided there, if procedures for reaching to information are not intuitive or are complicated, or if very long time is needed for displaying the information, it is difficult to increase the access rate or to acquire customers.

Not to lag behind the current of the times, and to continuously maintain and improve the usability of the web services for attempting differentiation from other sites, it is essential to perform appropriate usability assessments. In order to perform the appropriate usability assessments, an arrangement is essential which collects information necessary for the assessments efficiently and which represents the usability performance in various and flexible forms using the collected information.

As a tool used for these usability assessments, for example, Japanese Patent Application Laid-open Publication No. 2001-51876 discloses a usability assessment apparatus for accurately logging system statuses as well as accurately reproducing the log to evaluate the ease of use of a system. Japanese Patent Application Laid-open Publication No. 8-161197 or HCI International 2003 Adjunct Proceedings, pp. 293-294, 2003 discloses a user interface assessment support apparatus and the like for storing a course of operations to a user interface shown on a window, determining the operation posing problems in the user interface based on the course of the stored operations or obtaining a degree of association among respective buttons on the user interface and displaying the results on the window. In accordance with this apparatus, workloads of assessors can be reduced by eliminating oversights of the assessors to prevent the assessors from failing to point out problems in the evaluation of the user interface. Also, incorporating the evaluation tool into a proxy server enables to capture page transition logs of users on the web, and complaints, ideas and desires harbored by the users when browsing the site via the Internet, without altering the site to be evaluated.

Also, Japanese Patent Application Laid-open Publication No. 2004-13242 discloses a method for supporting the usability assessments, wherein an assessment-target system does not have to be changed for the assessments by making a prompter-window correspond to each user interface of the assessment-target system involving transitions among multiple user-interface windows in advance, by displaying the corresponding prompter-windows when the user-interface windows of the assessment-target system are displayed, by storing user inputs to the prompter-windows and by sending the user data input from the prompter-windows to the assessment system. In accordance with this method, subjective assessment results from users can be obtained, along with log data for screen transitions operated by the users, in order to perform the usability assessments of the web sites on the Internet.

Japanese Patent Application Laid-open Publication No. 2003-316613 discloses a usability test system comprising simulation means for enabling simulated operations of an object on a terminal screen of a subject based on operations of the subject and information memory means for storing operation logs for each subject in association with execution of the simulation for provided questions, which enables analysis of operationality of the object and the like based on the operation logs obtained from the information memory means. In accordance with this system, a reliable usability test can be performed at low cost over a short amount of time.

By the way, in the usability assessments, it is important whether users themselves decide that the web service is easy to use, i.e. it is important to obtain users' subjective evaluation to usability. However, since the both techniques disclosed in Japanese Patent Application Laid-open Publication No. 2001-51876 and Japanese Patent Application Laid-open Publication No. 8-161197 use only the operation logs of users as targets of the analysis, users' subjective evaluation can not be known accurately. Also, since the technique disclosed in Japanese Patent Application Laid-open Publication No. 2003-316613 performs the usability assessments with operation logs, subjective evaluation can not be obtained.

The techniques disclosed in Japanese Patent Application Laid-open Publication No. 8-161197, Japanese Patent Application Laid-open Publication No. 2004-13242 and HCI International 2003 Adjunct Proceedings, pp. 293-294, 2003 obtain web page transition logs, and complaints, ideas and desires harbored by the users on the proxy server. However, since web sites increasingly provide dynamic contents operating only on the client side, it is difficult to accurately perform the usability assessments to these dynamic contents with the techniques sited in Japanese Patent Application Laid-open Publication No. 8-161197, Japanese Patent Application Laid-open Publication No. 2004-13242 and HCI International 2003 Adjunct Proceedings, pp. 293-294, 2003 which obtain data needed for the assessments on the server side. In the technique disclosed in Japanese Patent Application Laid-open Publication No. 2004-18242, evaluations input by users are output to a user answer DB, associating with a scenario which is definitions of query contents and answer methods to the assessment windows, and results of the assessments are output in the form associated with the scenario. However, in order to enable exact usability assessments to contents with expressions and functions increasingly broadened and complicated, arrangements are needed for providing assessment results expressed in more various and flexible forms.

### SUMMARY OF THE INVENTION

A purpose of the present invention is to provide an information processing system, information processing apparatus, control method of the information processing system and a computer readable program which can provide usability assessment information in various forms by collecting usability assessment information efficiently and utilizing the collected information effectively.

In the present invention, a first information processing apparatus displays a window for the content on a display device depending on operations to an input device; the first information processing apparatus obtains feedback operation logs including assessment information for the window and date-time information when the assessment information has been input; the first information processing apparatus obtains operation logs including operation information to the input device and date-time information when the operation has been input; the first information processing apparatus obtains communication logs including date-time information when the window has been displayed and information for identifying the window; the first information processing apparatus sends to a second information processing apparatus the feedback operation logs, the operation logs and the communication logs; the second information processing apparatus receives from the first information processing apparatus the feedback operation logs, the operation logs and the communication logs; the second information processing apparatus correlates information included in at least two of the feedback operation logs, the operation logs and the communication logs in chronological order based on the date-time information included in each log; and usability assessment information is thus generated for the content.

According to the present invention, usability assessment information can be provided in various and flexible expression forms, since the feedback operation logs, the operation logs and the communication logs are correlated in chronological order based on the date-time information included in each log.

### BRIEF DESCRIPTION OF THE DRAWINGS

FIG. 1 shows a schematic structure of a usability assessment system 1 of the present invention;

FIG. 2 shows an example of a structure of a computer used as hardware of a terminal for assessor 10, a web server 20 or a server for assessments 30 of the present invention;

FIG. 3A shows various functions achieved in the terminal for assessor 10 of the present invention;

FIG. 3B shows contents of a database 11 of the present invention;

FIG. 4 shows an assessment window 400 displayed by a web browser running on the terminal for assessor 10 when a user performs usability assessments to content, according to the present invention;

FIG. 5 shows a case that the comment input field 414 of FIG. 4 is displayed in a window 500 separated from an assessment window 400 displaying the content, according to the present invention;

FIG. 6 is a diagram describing an embodiment for enabling a user to specify any position on the window for assessments, according to the present invention;

FIG. 7 is a flowchart describing processing executed by a feedback event handler 311 of the present invention;

FIG. 8 is a flowchart describing processing executed by an operation event information acquisition component 312 of the present invention;

FIG. 9 is a flowchart describing processing executed by a content event information acquisition component 313 of the present invention;

FIG. 10 shows feedback operation logs 372 stored by the feedback event handler 311 out of assessment information stored into the database 11, according to the present invention;

FIG. 11 shows operation logs 371 stored by the operation event information acquisition component 312 out of assessment information stored into the database 11, according to the present invention;

FIG. 12 shows communication logs 373 stored by the content event information acquisition component 313 out of assessment information stored into the database 11, according to the present invention;

FIG. 13 is a flowchart describing processing for transmission of assessment information from a terminal for an assessor 10 to a server for assessments 30, according to the present invention;

FIG. 14 shows a window of assessment result generated by an assessment information generator 392 based on a feedback operation log table 1000 shown in FIG. 10, and displayed on a display device 214 of the server for assessments 30, according to the present invention;

FIG. 15 shows a tabulated result table 1500 generated based on the information in the feedback operation log table 1000, operation log table 1100 and communication log table 1200, used for generation of the window for assessment result shown in FIG. 16, according to the present invention;

FIG. 16 shows the window for assessment result 1600 generated based on the tabulated result table 1500, according to the present invention;

FIG. 17 shows the window for assessment result generated with the use of the tabulated result table 1500, according to the present invention; and

FIG. 18 shows a comment list window 1800 displayed in the case of clicking a comment display button 1720b of FIG. 17, according to the present invention.

### DETAILED DESCRIPTION OF THE INVENTION

An embodiment of the present invention will now be described in detail along with the drawings.

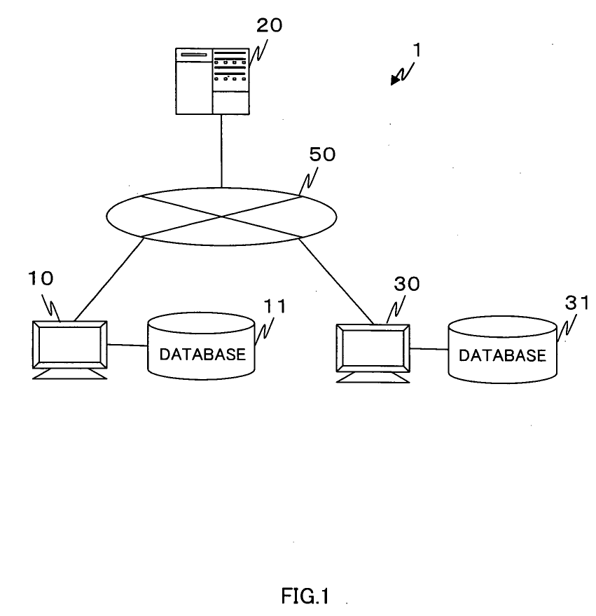

FIG. 1 shows a schematic structure of a usability assessment system 1 described as an embodiment of the present invention. One or more terminal for an assessor 10 (a first information processing apparatus), a web server 20 (a second information processing apparatus) and a server for assessments are respectively connected via communication network 50. Specific examples of the communication network 50 include the Internet, private lines, phone lines, LAN (Local Area Network), WAN (Wide Area Network) and the like. In this embodiment, TCP/IP and HTTP (Hypertext Transfer Protocol) are used as communication protocols in the communication network 50.

The web server 20 is a computer for distributing content, which is to be a target of usability assessments, to apparatuses connected to the communication network 50. The terminal for assessor 10 is a computer operated by a user who performs the usability assessments. The user performs the usability assessments to the content such as a web page distributed from the web server 20 by inputting URL (Uniformed Resource Locator) to a web browser running on the terminal for assessor. The web browser incorporates a plug-in program achieving user interfaces for an operator of the terminal for assessor 10 inputting information on assessments of the content (hereinafter, referred to as assessment information). An install program for incorporating the plug-in program into the web browser is supplied to the terminal for assessor 10 by downloading from the server for assessments or the web server or from a portable recording medium. A plug-in ID is assigned to each plug-in program incorporated into the web browser, as an identifier. The plug-in ID is stored and managed by the terminal for assessor 10 to which the plug-in program is installed. The plug-in ID is utilized when the server for assessments 30 comprehends what terminal for assessor 10 runs the plug-in program performing a notification, for example. The assessment information obtained by the plug-in program is stored in a database 11 accessible to the terminal for assessor 10. In this embodiment, it is assumed that the database 11 is achieved as a function of the plug-in program.

The assessment information input with the terminal for assessor 10 and stored in the database 11 is transmitted to and accumulated in the server for assessments 20 via the communication network 50 or a portable recording medium. The assessment information transmitted to and accumulated in the server for assessments 20 is stored in a database 31 accessible to the server for assessments 20.

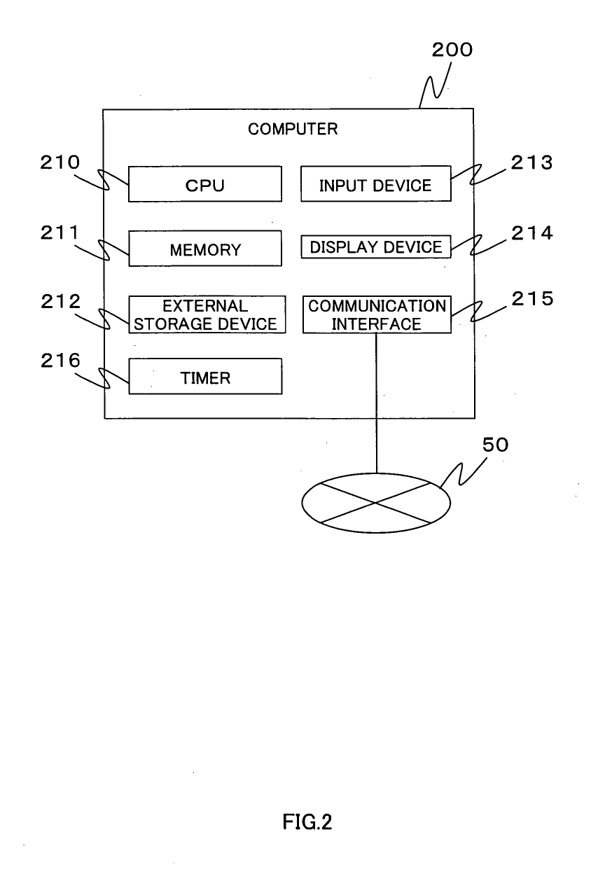

FIG. 2 shows an example of a hardware structure of a computer used as the terminal for assessor 10, the web server 20 or the server for assessments 30. The computer 200 is comprised of a CPU (Central Processing unit) 210, a memory 211 which is primary storage consisting of RAM, ROM or the like, an external storage device 212 such as a hard disk device, IC memory card, CD-ROM, CD-R, DVD-ROM, DVD-RAM or DVD-R/RW, an input device 213 such as a keyboard, mouse, touch panel, bar-code reader or voice recognition device, a display device 214 such as a CRT display, liquid crystal display or organic EL (Electro Luminescence) display, a communication interface 215 such as a NIC (Network Interface Card), and a timer 216 for generating date-time information. These components are connected via a bus 220 enabling communications. The CPU 210 performs supervisory control of the computer 160. The memory 211 stores programs executed by the CPU 210 and data input from or output to the external storage device 214 and the like. The communication interface 215 connects the computer 200 to the communication network 50.

The terminal for assessor 10, the web server 20 and the server for assessments 30 do not necessarily have to be comprised of the entire structure shown as the above hardware and may be comprised at least of a structure needed for achieving each function. Specific examples of the computer used as the terminal for assessor 10 include personal computers, office computers, portable information terminals such as a PDA (Personal Data Assistant) and a CPU built-in cellular phone, and public broadcast receivers (analog broadcast receiver and digital broadcast receiver) equipped with the Internet connection function. Specific examples of the computer used as the web server 10 or the server for assessments 30 include personal computers, office computers, main frames and disk-array devices.

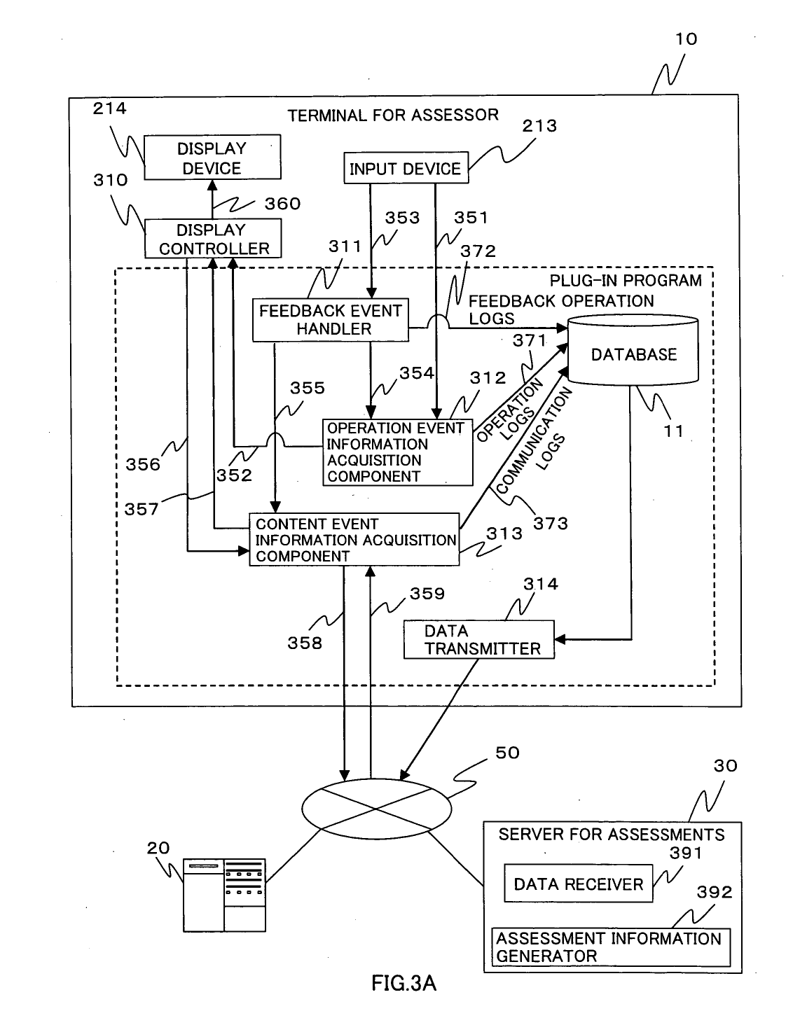

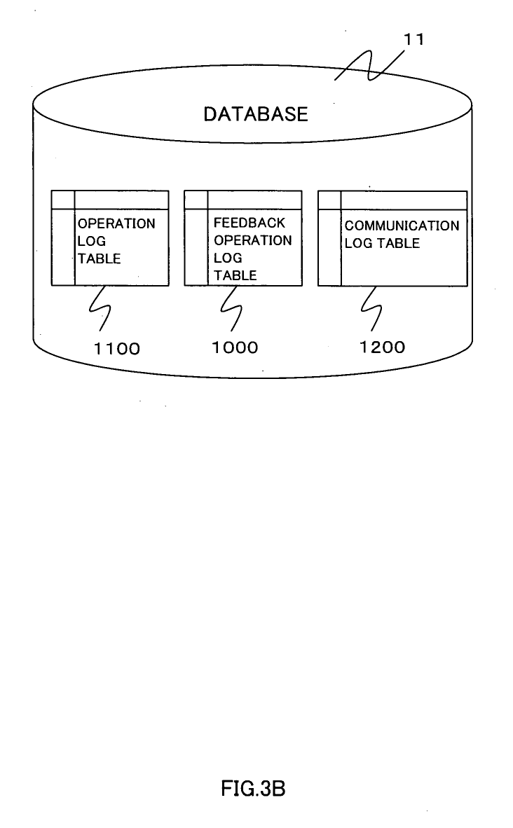

FIG. 3A shows various functions achieved in the terminal for assessor 10. These functions are achieved by functions possessed by the hardware of the terminal of assessor 10 or by executing the programs stored in the memory 211 with the CPU 210. In FIG. 3A, functions depicted inside broken lines are achieved by executing the plug-in program described above.

In FIG. 3A, an operation event information acquisition component 312 obtains input information 351 on operations other than the operation associated with content assessments out of input information notified from the input device 213 depending on input operations of the user, and stores into the database 11 the information generated based on the input information 352 as logs for operations (hereinafter, referred to as “operation logs 371”). Also, the operation event information acquisition component 312 notifies a display controller 310 of the acquired input information (352).

A feedback event handler 311 obtains information 353 showing operations associated with the content assessments out of input information notified from the input device 213 depending on input operations of the user, and stores into the database 11 the information generated based on the input information 353 as logs for operations associated with assessments (hereinafter, referred to as “feedback operation logs 372”). Also, the feedback event handler 311 notifies the operation event information acquisition component 312 and a content event information acquisition component 313 of an assessment-start instruction which is an instruction for starting acquisition of information associated with assessments and an assessment-end instruction which is an instruction for terminating the acquisition depending on the obtained input information (354, 355).

When the assessment-start instruction for the information associated with assessments is notified by the feedback event handler 311, the content event information acquisition component 313 sends a content acquisition request 358 to the web server 20 via the communication network 50 while communicating with the display controller 310 (356, 357), and receives content expression data 359 which are data for displaying the content (for example, HTML (Hypertext Markup Language) texts, XML (Extensible Markup Language) texts, programs executed in conjunction with or independently from these texts and other data associated with the content). Also, the content event information acquisition component 313 stores into the database 11 the logs for communications performed with the web server 20 on this occasion (hereinafter, referred to as “communication logs 373”).

The display controller 310 notifies the content event information acquisition component 313 of instruction information 356 such as URL of the content which is to be obtained, based on the input information 352 notified by the operation event information acquisition component 312. Also, the display controller 310 generates a window based on the content expression data 357 notified by the content event information acquisition component 313 and displays the window on the display devise 214 (360). A data transmitter 314 transmits to the server for assessments 30 the feedback operation logs 372, the operation logs 371 and the communication logs 373 stored in the database at the timing of the scheduled data and time or at appropriate timings when upload requests are received from the server for assessments 30. FIG. 3B shows the data stored in the database 11. The operation logs 371, the feedback operation logs 372 and the communication logs 373 are stored in the database 11 as an operation log table 1100, a feedback operation log table 1000 and a communication log table 1200, respectively.

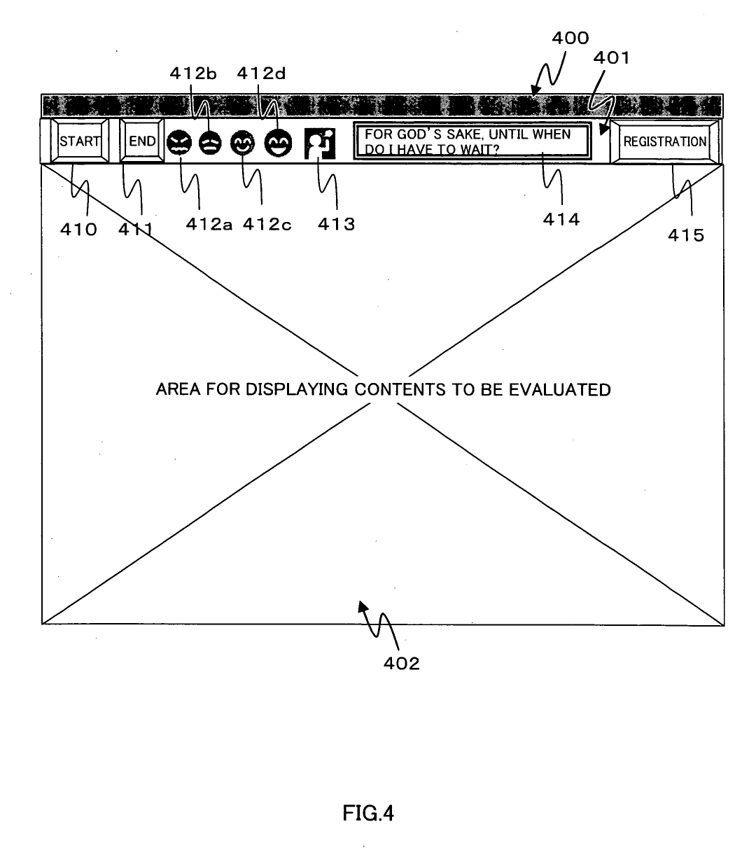

FIG. 4 shows a window displayed by a web browser running on the terminal for assessor 10 when a user performs usability assessments to content (hereinafter, referred to as “an assessment window 400”). This window is displayed by the function of the display controller 310. The user inputs an assessment to the content displayed in a lower area 402 using user interfaces for inputting information associated with the usability assessments, which is provided in an upper area 401 of the window. The user interfaces are displayed by the function of the plug-in program described above.

Among the user interfaces provided in the upper area 401, an assessment-start button 410 is a button for indicating an intention to start assessments to the content. An assessment-end button 411 adjacent to the right thereof is a button for indicating an intention to end assessments to the content. When the assessment-start button 410 is clicked, the feedback event handler 311 is notified of clicking the button as input information from the input device 213, and the operation event information acquisition component 312 is notified of the assessment-start instruction for the information associated with the assessments described above. When the assessment-end button 411 is clicked, the feedback event handler 311 is notified of clicking the button as input information from the input device 213, and the operation event information acquisition component 312 is notified of the assessment-end instruction for the information associated with the assessments described above.

Among the user interfaces, buttons enabling the user to provide their impression 412a to 412d are buttons for expressing impressions felt about contents. 412a and 412b are buttons for expressing negative impressions, and 412c and 412d are buttons for expressing positive impressions. The user can easily assess contents by clicking one of multiple buttons enabling the user to provide their impression 412a to 412d provided correspondingly to types of the assessments in this way. When the user clicks the button corresponding to the impression felt about an image displayed in the lower area 402, the database 11 stores, as the feedback operation logs 372, the information indicating the type of the assessment comprehended based on information indicating which button is clicked out of buttons enabling the user to provide their impression 412a to 412d.

Among the user interfaces, a comment input field 414 is a field for inputting comments to contents. The comments input to the comment input field 414 are stored into the database 11 as the feedback operation logs 372 by clicking a registration button 415. A comment-only input button 413 adjacent to the right of the buttons enabling the user to provide their impression 412a to 412d is clicked when the user wants to input only the comment without performing the assessments using the buttons enabling the user to provide their impression 412a to 412d.

The aspects of the user interfaces described above are merely shown by way of an example. For example, the buttons enabling the user to provide their impression may be provided in different numbers from this example. Also, the display layout of the user interfaces is not limited to this, and the user interfaces may be provided in a right, left or bottom area of the web browser.

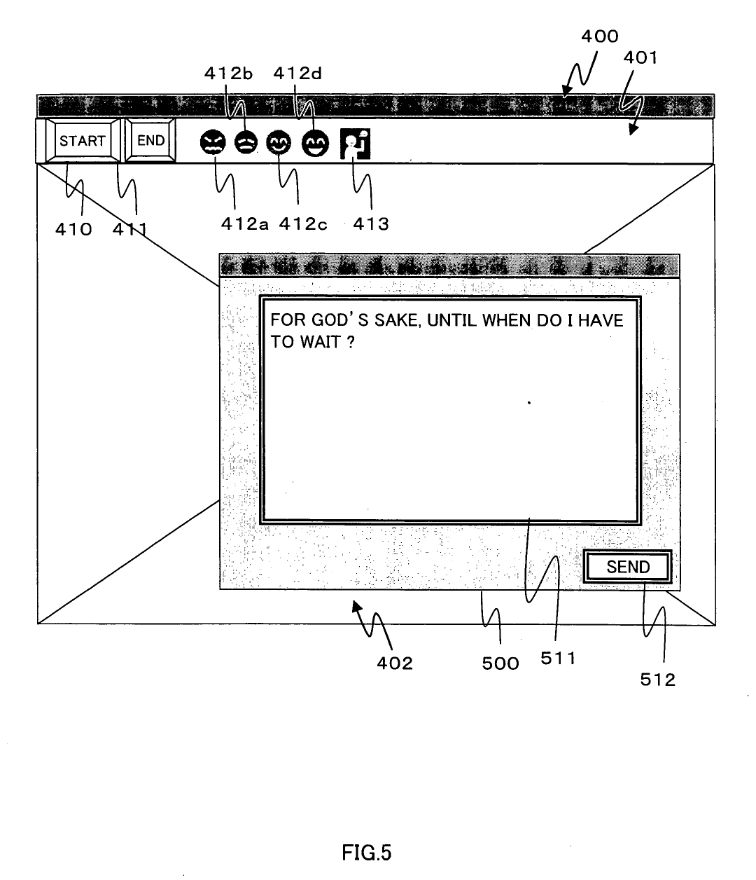

FIG. 5 shows an arrangement for displaying the comment input field 414 of FIG. 4 in a window 500 separated from the assessment window 400 displaying the content. In this figure, when the user clicks the buttons enabling the user to provide their impression 412a to 412d or the comment-only input button 413, a separate window 500 is displayed as a popup, which shows a comment input field 511. When the user inputs a comment and clicks a send button 512, the input comment is stored into the database 11 as the feedback operation log 372. Also, when the send button 512 is clicked, the separate window 500 disappears. The separate window 500 is displayed by being associated with the function of the feedback event handler 311.

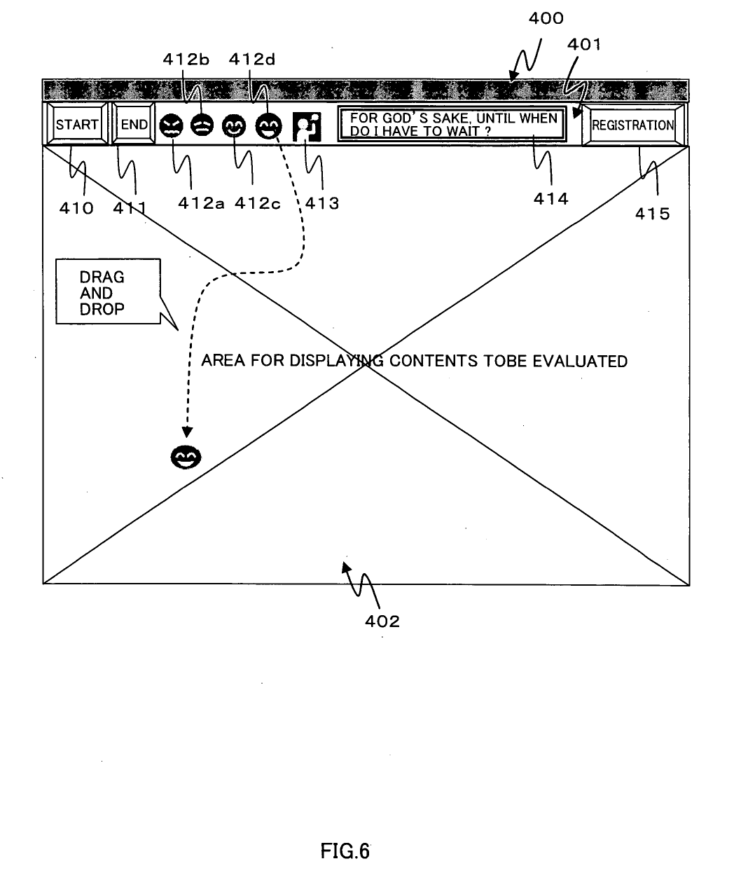

FIG. 6 describes an embodiment for enabling a user to specify any position on the window for assessments. The user can specify a position to be assessed on the window displayed in the lower area 402 by dragging and dropping the buttons enabling the user to provide their impression 412a to 412d or the comment-only input button 413 to any position in the lower area 402. The specification of the position can be performed by clicking the buttons enabling the user to provide their impression 412a to 412d or the comment-only input button 413 and then clicking the position desired to be specified. The information indicating the position is stored into the database 11 along with the information associated with the assessments performed for the position.

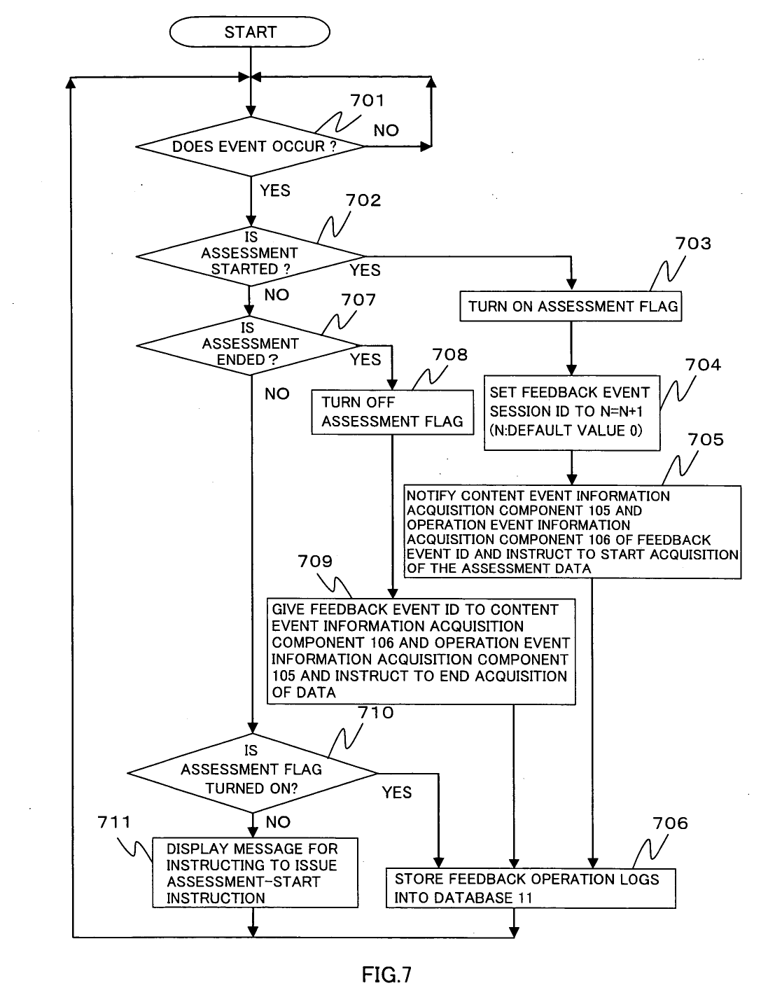

FIG. 7 is a flowchart describing processing executed by the feedback event handler 311, among the functions of the plug-in program shown in FIG. 3. The feedback event handler 311 waits for an event relating to the operations for content assessments (hereinafter, referred to “a feedback event”) (step 701). When a feedback event occurs (step 701: YES), the feedback event handler 311 decides whether the event is an event for instructing start of assessments or not (step 702). If it is decided that the event is an event for instructing start of assessments (step 702: YES), the feedback event handler 311 turns on an assessment flag indicating that the assessments are being performed (step 703). Also, the feedback event handler 311 adds 1 to the value of the counter of a feedback event session ID which is a default value (step 704). The session means a period from when the user performs the operation for starting the assessments to when the user performs the operation for terminating the assessments. The feedback event handler 311 notifies the operation event information acquisition component 312 and the content event information acquisition component 313 of the feedback event ID and of an instruction indicating that the acquisition of the assessment information should be started (step 705). Also, the feedback event handler 311 starts to store the feedback operation logs 372 into the database 11 (step 706).

In step 706, the feedback event handler 311 generates a feedback event log ID which is an ID for uniquely identifying the feedback operation log 372 and the feedback operation log 372 stored in the database 11 is accompanied by the feedback event log ID. Also, in step 706, the feedback event handler 311 obtains data for generating a window currently displayed on the display device 214 by the functions of the display controller 310 (hereinafter, referred to as “hardcopy data”). The obtained hardcopy data are associated with the feedback event log ID as a file given a file name (hereinafter, referred to as “a picture image file”) and are stored into the database 11 as accompanying information of the feedback operation logs 372.

In step 702, if the feedback event generated is not an event for instructing start of assessments (step 702: NO), it is decided whether the event is an event for instructing end of assessments or not (step 707). If the feedback event is an event for instructing end of assessments (step 770: YES), the assessment flag is turned off (step 708), and the operation event information acquisition component 105 and the content event information acquisition component 106 is notified of the feedback event session ID and of an instruction indicating that the acquisition of the assessment information should be ended (step 709). Then, the processing proceeds to step 706.

In step 707, if the event is not an event for instructing end of assessments (step 770: NO), it is further decided whether the assessment flag is on or not (step 710). If the assessment flag is on (step 710: YES), the processing proceeds to step 706. If the assessment flag is off (step 710: NO), a message is displayed on the display device 214 in order to instruct the user to issue an assessment-start instruction (step 711) and the processing is returned to the reception waiting state for the feedback event (step 701).

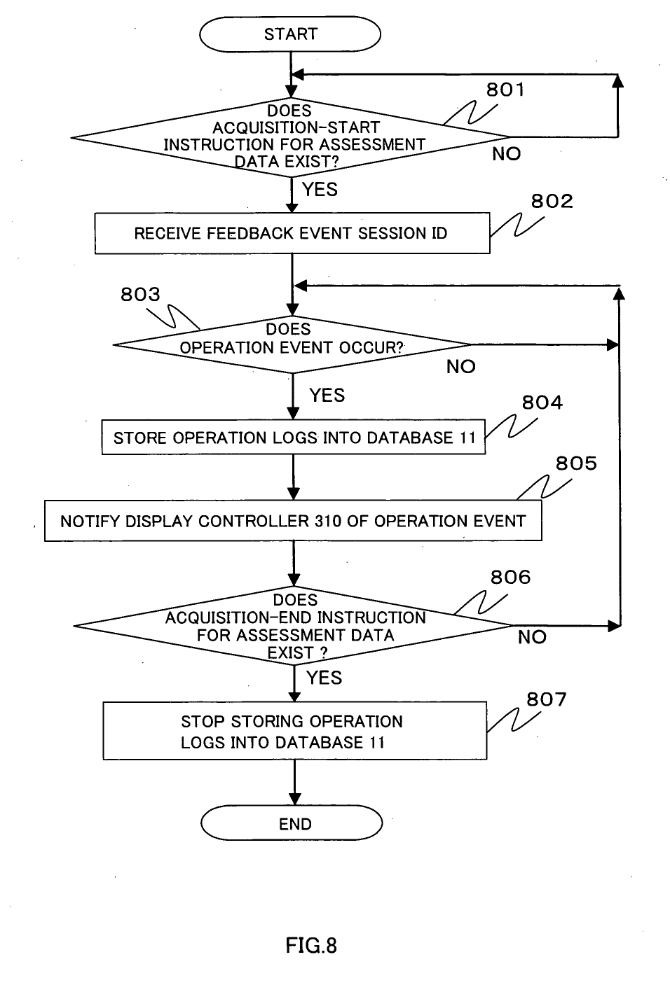

FIG. 8 is a flowchart describing processing executed by the operation event information acquisition component 312, among the functions of the plug-in program shown in FIG. 3. In step 705 of FIG. 7, the operation event information acquisition component 312 waits for an acquisition-start instruction for the assessment information sent from the feedback event handler 311 (step 801). The operation event information acquisition component 312 waits for generation of an event relating to the operations for other than the contents assessments (hereinafter, referred to as “an operation event”) (step 803). When the operation event is generated (step 803: YES), the operation event information acquisition component 312 starts to store the operation logs to the database 11 (step 804). In step 804, the operation event information acquisition component 312 generates an operation log ID which is an ID for uniquely identifying the operation log 371 and the operation log 371 stored in the database 11 is accompanied by the operation log ID. Also, the operation event information acquisition component 312 associates the operation log with the feedback event session ID obtained in step 802 and stores the operation log into the database 11. In step 805, the operation event information acquisition component 312 notifies the display controller 310 of the operation event (step 805).

In step 806, the operation event information acquisition component 312 checks whether the acquisition-end instruction for the assessment information is sent from the feedback event handler 311 or not (step 806). If the acquisition-end instruction exists (step 806: YES), the storage of the operation logs into the database 11 is stopped (step 807). If the acquisition-end instruction does not exist (step 806: NO), the processing proceeds to step 803 to wait for the generation of the operation event (step 803).

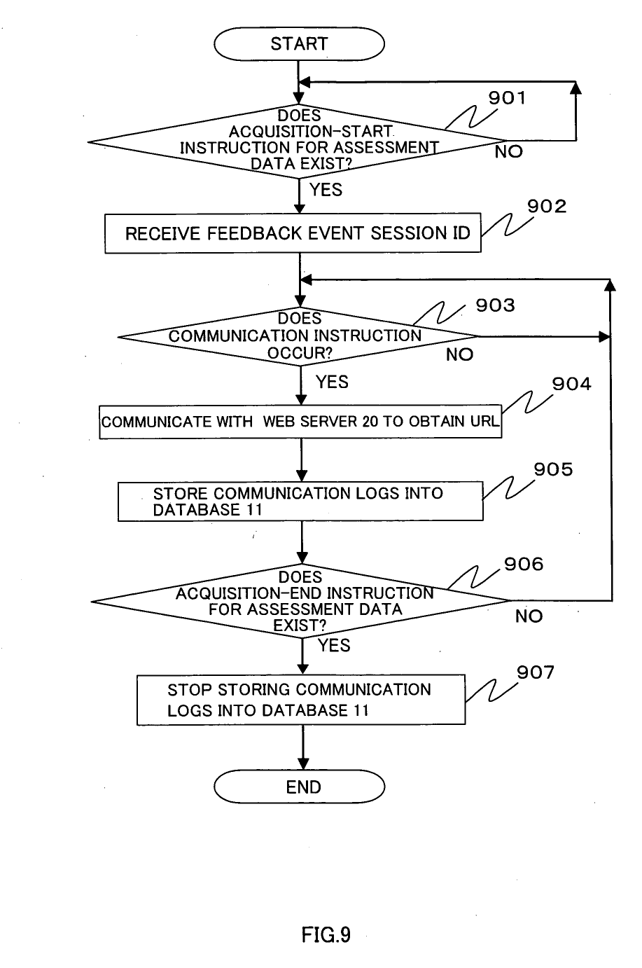

FIG. 9 is a flowchart describing processing executed by the content event information acquisition component 313, among the functions of the plug-in program shown in FIG. 3. In step 705 of FIG. 7, the content event information acquisition component 313 waits for the acquisition-start instruction for the assessment information sent from the feedback event handler 311 (step 901). When the acquisition-start instruction is notified (step 901: YES), the content event information acquisition component 313 receives the feedback event session ID (step 902) and waits for generation of an instruction for communicating with the web server 20 notified from the display controller 310 (step 903). When the communication instruction is generated (step 903: YES), the content event information acquisition component 313 communicates with the web server 20 to obtain the URL of the content which is an object of the communication (step 904). The communication log is stored into the database 11 along with the feedback event session ID (step 905). The communication log stored into the database 11 includes a URL obtained from a communication performed before the above communication. In step 905, the content event information acquisition component 313 generates a content log ID which is an ID for uniquely identifying the communication log 373 and the communication log 371 stored in the database 11 is accompanied by the content log ID.

In step 906, the content event information acquisition component 313 checks whether the acquisition-end instruction for the assessment information is sent from the feedback event handler 311 or not (step 906). If the acquisition-end instruction exists (step 906: YES), the acquisition of the URL is stopped and the storage of the communication logs into the database 11 is stopped (step 907). If the acquisition-end instruction does not exist (step 906: NO), the processing proceeds to step 903 to wait for the generation of the operation event (step 903).

As described above, in the usability assessments system 1 of this embodiment, the assessment information such as the feedback operation logs 372, the operation logs 371 and the communication logs 373 is obtained by the functions of the plug-in program running on the client side. Therefore, accurate usability assessments can be performed, even to the dynamic contents constructed to achieve transitions of web pages on the client side.

Then, descriptions are made for the feedback operation logs 372, the operation logs 371 and the communication logs 373 which are the assessment information obtained and stored into the database as described above.

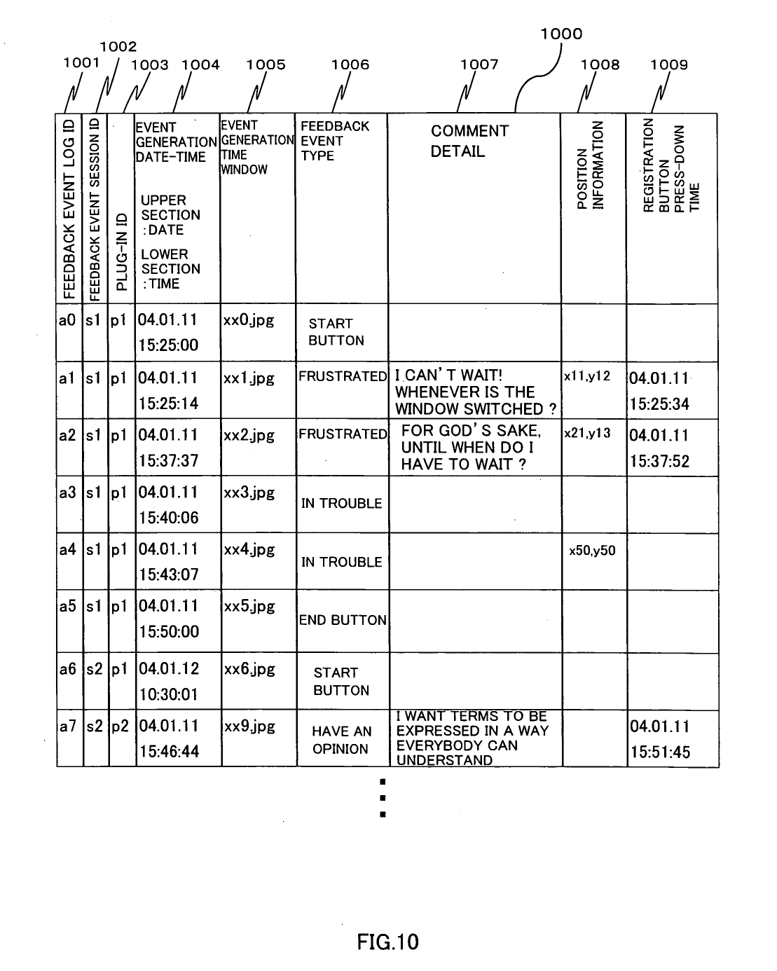

FIG. 10 is an example of the feedback operation logs 372 stored by the feedback event handler 311. In this way, the feedback operation logs 372 are stored into the database 11 as a table listing the multiple feedback operation logs 372 in chronological order (the feedback operation log table 1000 shown in FIG. 3B). One line of the data of FIG. 10 corresponds to one feedback operation log 372.

A feedback event log ID field 1001 lists the feedback event log IDs which are IDs for uniquely identifying the feedback operation logs 372. The feedback event log IDs are generated in step 706 of FIG. 7. A feedback event session ID field 1002 lists IDs for correlating events generated from when start of the assessment is instructed to when end of the assessment is instructed, i.e., IDs given to each session. The feedback event session IDs are generated in step 704 of FIG. 7 as described. A plug-in ID field 1003 lists plug-in IDs which are IDs given to the plug-in programs. An event generation time field 1004 lists dates and times of generation of the feedback events. These dates and times are the dates and times when the generation of the feedback events are detected in step 701 and are obtained from the timer 216.

An event generation time window field 1005 lists file names of files recording the hard copy data obtained in step 706 of FIG. 7. A feedback event type field 1006 lists feedback event types which are information indicating the user operations which have generated the events. The feedback event types are, for example, information indicating clicking of the assessment-start button 410, the assessment-end button 411, the buttons enabling the user to provide their impression 412a to 412d and the comment-only input button 413 shown in FIG. 4 to FIG. 6, and information identifying which button is clicked out of the buttons enabling the user to provide their impression 412a to 412d. A comment detail field 1007 lists character strings input into the comment input field 414 shown in FIG. 4 and FIG. 6 or the comment input field 511 shown in FIG. 5. This field may be blank in the feedback operation log 372, and this means that the user has not input a comment. A position information field 1008 lists position coordinates indicating positions specified by the user in FIG. 6. These position coordinates are position coordinates set in the lower area 402 which is the area of the web browser for displaying the contents. This field may be blank in the feedback operation log 372, and this means that the user has not specified a position in the window. A registration button press-down time field 1009 lists clock times when the registration button 415 of FIG. 4 or FIG. 6 or the send button 512 of FIG. 5 is clicked.

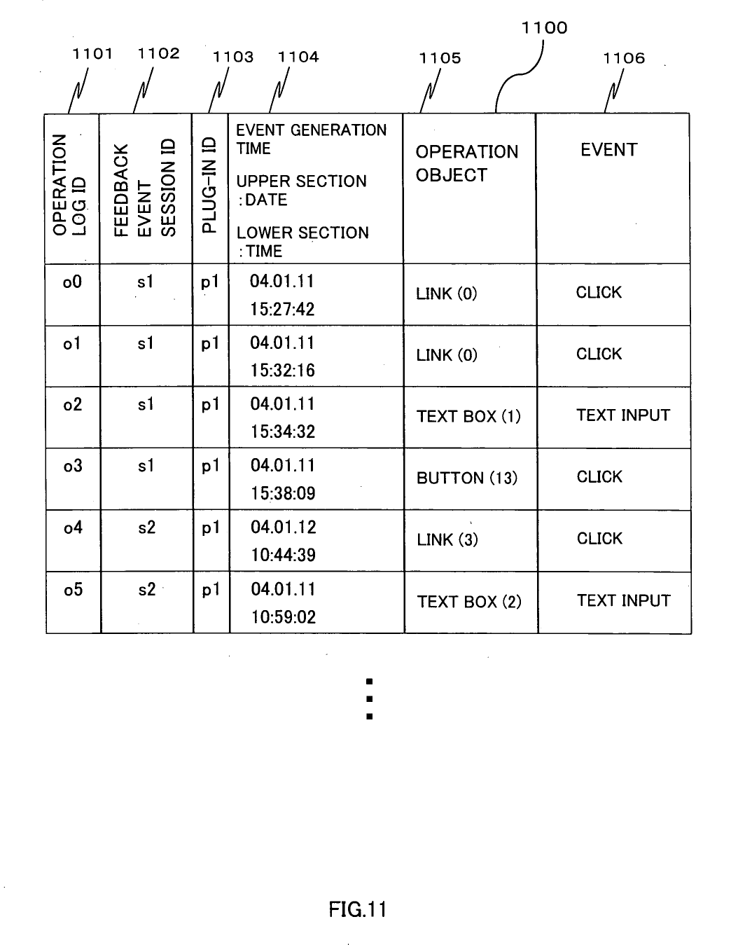

FIG. 11 shows an example of the operation logs 371 stored by the operation event information acquisition component 312 out of assessment information stored into the database 11. In this way, the operation logs 371 are stored into the database 11 as a table listing the multiple operation logs 371 in chronological order (the operation log table 1100 shown in FIG. 3B). One line of the data of FIG. 11 corresponds to one operation log 371.

An operation log ID field 1101 lists the operation log IDs which are IDs for uniquely identifying the operation logs 371. The operation log IDs are generated in step 804 of FIG. 8. A feedback event session ID field 1102 lists the feedback event session IDs notified from the feedback event handler 311 in step 705 of FIG. 7. A plug-in ID field 1103 lists the plug-in IDs which are IDs given to the plug-in programs. An event generation date-time field 1104 lists dates and times of generation of the operation events. These dates and times are the dates and times when the generation of the operation events are detected in step 803 and are obtained from the timer 216. An operation object field 1105 lists information identifying objects which are targets of operations generating the operation events. In FIG. 11, the names of the objects are listed as this information. In this field 1105, numeric values shown in parentheses are IDs for identifying objects if multiple objects with the same name exist. An event field 1106 lists information indicating specific details of the operation events.

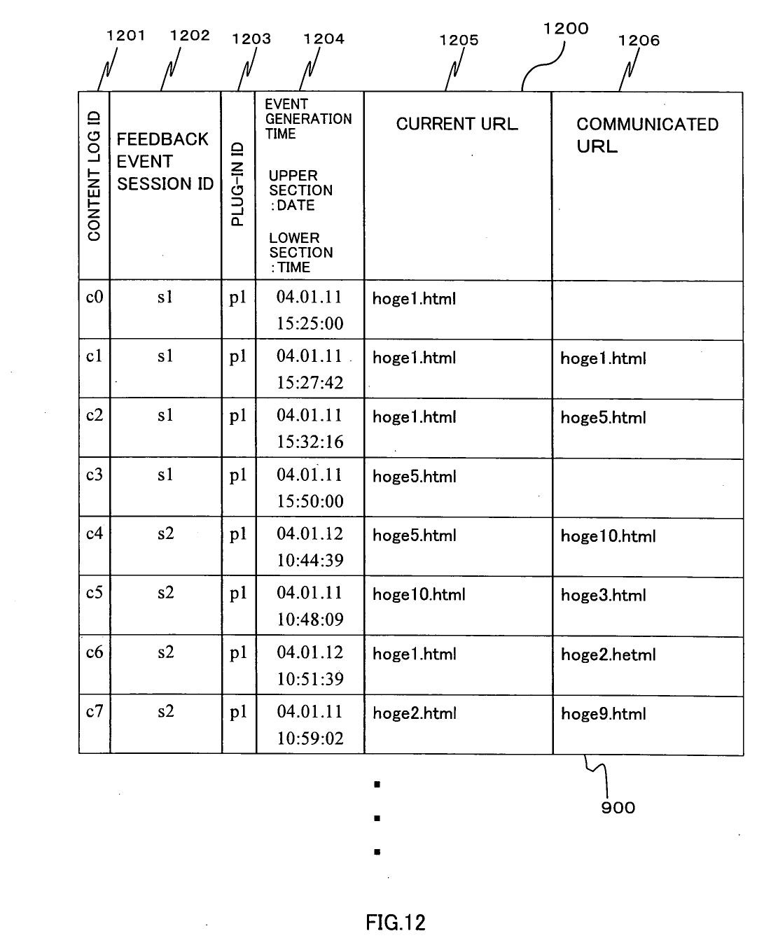

FIG. 12 shows an example of the communication logs 373 stored by the content event information acquisition component 313 out of assessment information stored into the database 11. In this way, the communication logs 373 are stored into the database 11 as a table listing the multiple communication logs 373 in chronological order (the communication log table 1200 shown in FIG. 3B). One line of the data of FIG. 12 corresponds to one communication log 373.

A content log ID field 1201 lists the content log IDs which are IDs for uniquely identifying the communication logs 373. The content log IDs are generated in step 905 of FIG. 9. A feedback event session ID field 1202 lists the feedback event session IDs notified from the feedback event handler 311 in step 705 of FIG. 7. A plug-in ID field 1203 lists the plug-in IDs which are IDs given to the plug-in programs. Common plug-in IDs are stored by the feedback event handler 311, the operation event information acquisition component 105 and the content event information acquisition component 106. An event generation date-time field 1204 lists dates and times of generation of the communication instructions. These dates and times are the dates and times when the generation of the communication instructions are detected in step 903 and are obtained from the timer 216. A current URL field 1205 lists URLs (Uniform Resource Locators) which are information identifying windows displayed until just before switching to new windows obtained by the communications (hereinafter, referred to as “current URLs”). A communicated URL field 1206 lists URLs which are information identifying windows newly obtained by the communications (hereinafter, referred to as “communicated URLs”).

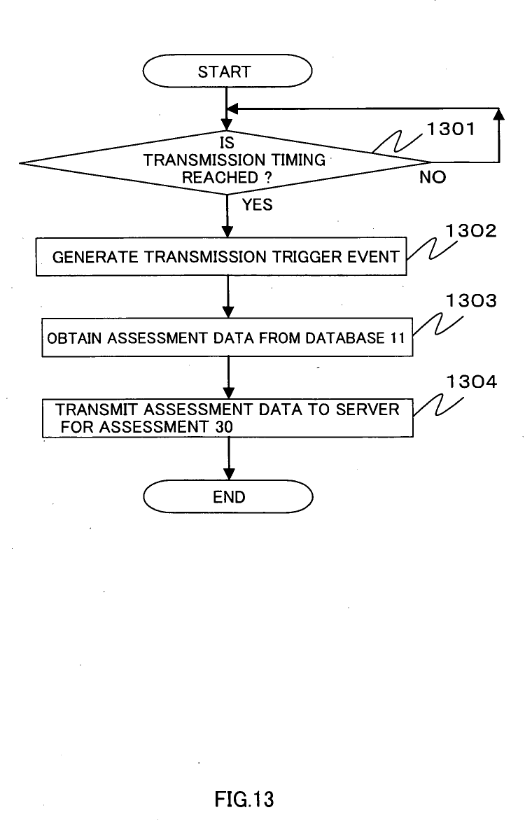

For the assessment information described above, i.e. the feedback operation log table 1000, the operation log table 1100 and the communication log table 1200, details are transmitted to the server for assessments 30 by the date transmitter 314 via the communication network 50 accordingly. At the time of transmission, various pieces of information are also transmitted to the server for assessments 30, which are used for the usability assessments, such as the picture image files described above. FIG. 13 is a flowchart describing processing for the transmission of the assessment information from the terminal for assessor 10 to the server for assessments 30. First, when the terminal for assessor 10 reaches the transmission timing set by a scheduler or the like (step 1301: YES), a transmission trigger event is generated (step 1302). The transmission trigger event may be generated when a threshold value is exceeded by a data size of at least one of the feedback operation log table 1000, the operation log table 1100 and the communication log table 1200 stored in the database 11, for example. The transmission trigger event may be generated in response to an explicit operation instruction to the input device 213 from the user. When the transmission trigger event is generated, the data transmitter 314 obtains the assessment information to be transmitted (step 1303) and transmits the obtained assessment information to the server for assessments 30 (step 1304). The transmitted assessment information is received by a data receiver 391 of the server for assessments 30.

Based on the assessment information transmitted by the terminal for assessor 10 and received by the data receiver 391 as described above, the server for assessments 30 generates information helping the usability assessments (assessment result information) and generates various windows listing the information (hereinafter, referred to as “windows of assessment results”). The window of assessment result is generated by an assessment information generator 392 achieved by the CPU of the server for assessments 30 executing programs stored in the memory, and is displayed on the display device 214 of the server for assessments 30. If a printing apparatus such as a printer is connected to the server for assessments 30, the window of assessment result can be printed on pieces of paper and the like.

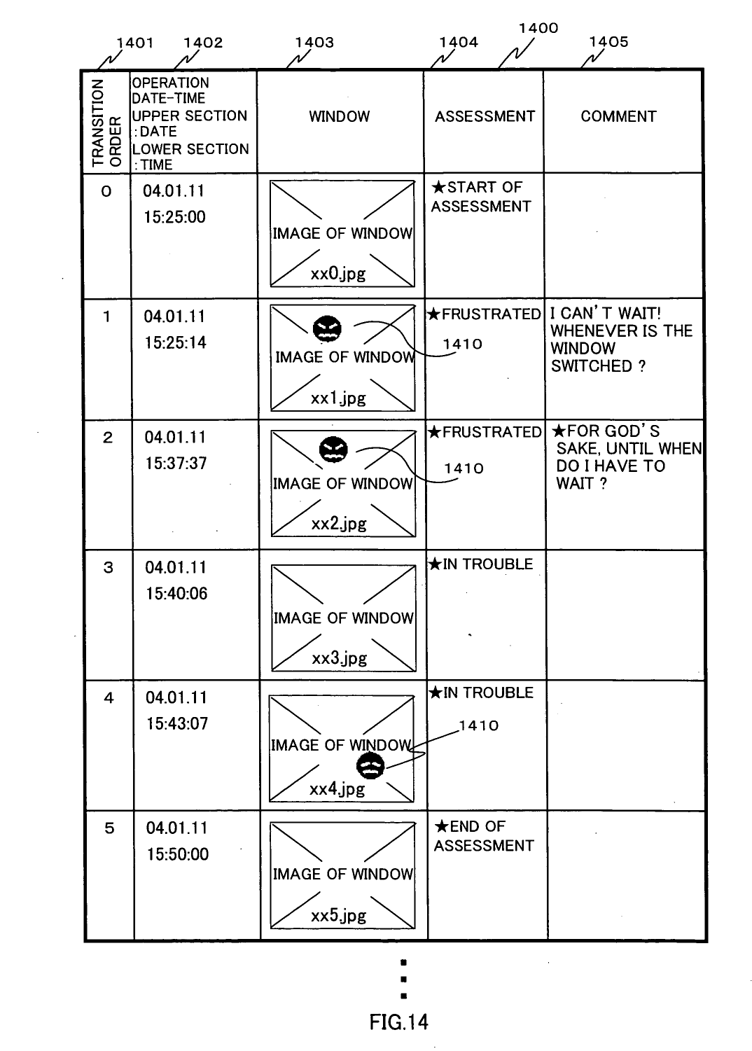

FIG. 14 is an example of the window of assessment result generated by the assessment information generator 392 based on the feedback operation log table 1000 shown in FIG. 10, and displayed on the display device 214 of the server for assessments 30. In the window of assessment result 1400, the information relating to the usability assessments input by the user is displayed in the order of the transitions of windows displayed on the web browser of the terminal for assessor 10 due to operational inputs when the user browses the contents.

A transition order field 1401 displays IDs given in the order of the transitions of the windows. An operation date-time field 1402 displays details listed in the event generation time field 1004 of the feedback operation log table 1000. A window field 1403 displays images generated based on the files corresponding to the file names listed in the event generation window field 1005 of the feedback operation log table 1000. If the position information is listed in position information field 1008 of the feedback operation log table 1000, a mark 1410 made from a design corresponding to the assessment performed by the user is displayed at the position corresponding to the position information in the window displayed in the window field 1403. The assessment information generator 392 stores correspondences between image data prepared for respective types of the marks and the event types listed in the feedback event type field 1006 of FIG. 10 and displays the marks 1410 generated based on the image data corresponding to the event types listed in the feedback event type field 1006 based on the correspondences on the window field 1403. An assessment field 1404 displays character strings indicating the event types listed in the feedback event type field 1006 of the feedback operation log table 1000. A comment field 1405 displays character strings listed in the comment detail field 1007 of the feedback operation log table 1000.

In accordance with the window of assessment result 1400 of FIG. 14, the assessor of the usability can easily understand what operation has been performed for which window by the user. Also, from the position of the mark superimposed and displayed on the hard copy, the assessor can easily understand what position on the window displayed on the web browser is assessed by the user. Also, from the design of the mark, the assessor can intuitively understand what type of the assessment has been performed. Further, since the assessments performed by the user are displayed in the order of the transitions of the windows, from the windows displayed in the vicinity, the assessor can easily understand what type of the assessment has been performed by the user at what stage of what operation.

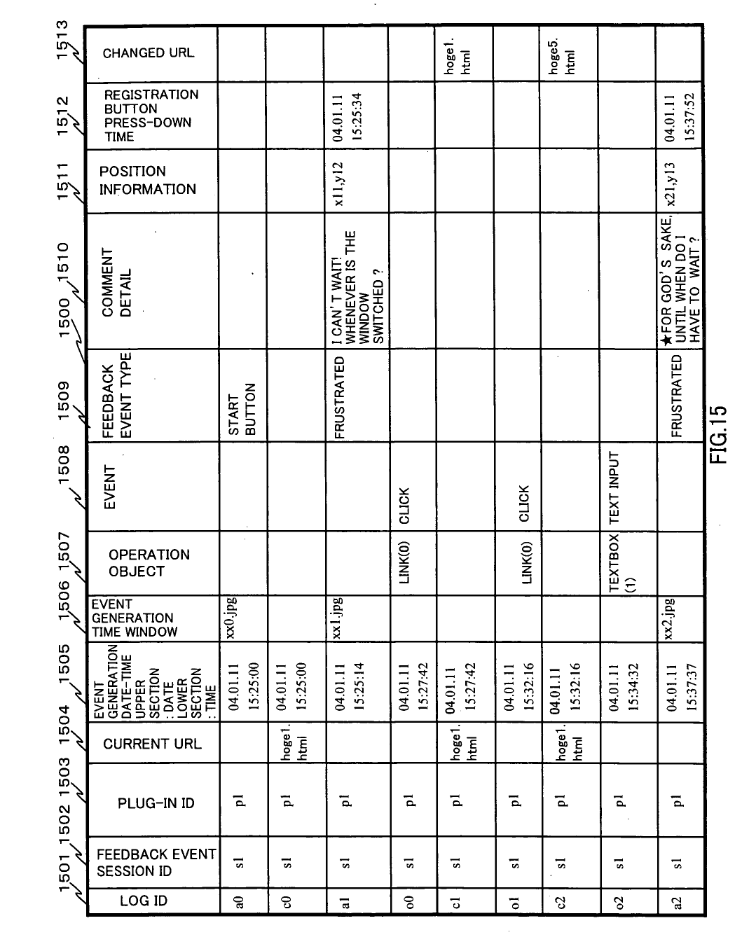

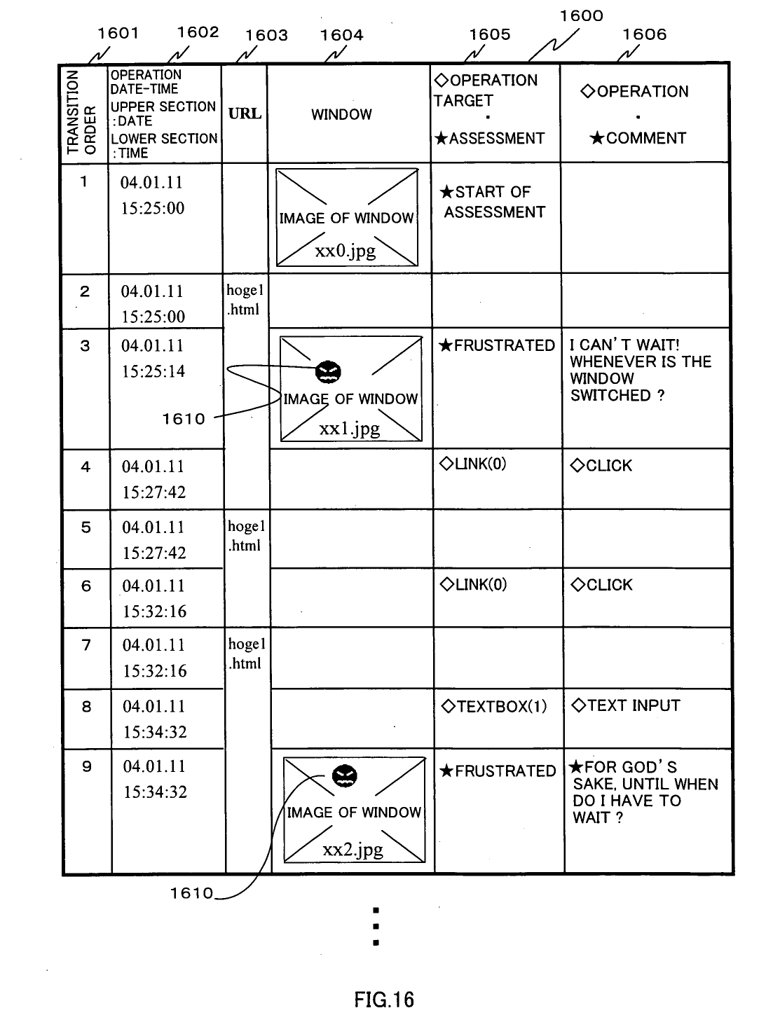

FIG. 16 is another example of the window for assessment result and FIG. 15 is a tabulated result table 1500 generated based on the information in the feedback operation log table 1000, the operation log table 1100 and the communication log table 1200, used for generation of the window for assessment result shown in FIG. 16. The tabulated result table 1500 is generated by reading the feedback operation logs 372, the operation logs 371 and the communication logs 373 and by sorting the read data using the plug-in ID as a first sort key, the feedback event session ID as a second sort key and the event generation time as a third sort key.

Details of a log ID field 1501 of the tabulated result table 1500 are the information respectively listed in the feedback event log ID field 1001 of the feedback operation log table 1000, the operation log ID field 1101 of the operation log table 1100 and the content log ID field 1201 of the communication log table 1200. Details of a feedback event session ID field 1502 are the information respectively listed in the feedback event session ID field 1002 of the feedback operation log table 1000, the feedback event session ID field 1102 of the operation log table 1100 and the feedback event session ID field 1202 of the communication log table 1200. Details of a plug-in ID field 1503 are the information respectively listed in the plug-in ID field 1003 of the feedback operation log table 1000, the plug-in ID field 1103 of the operation log table 1100 and the plug-in ID field 1203 of the communication log table 1200.

Details of a current URL field 1504 are the information listed in the current URL field 1205 of the communication log table 1200. Details of an event generation time field 1505 are the information respectively listed in the event generation date-time field 1004 of the feedback operation log table 1000, the event generation date-time field 1104 of the operation log table 1100 and the event generation date-time field 1204 of the communication log table 1200. Details of an event generation time window field 1506 are the information listed in the event generation time window field 1005 of the feedback operation log table 1000. Details of an operation object field 1507 are the information listed in the operation object field 1105 of the operation log table 1100. Details of an event field 1508 are the information listed in the operation object field 1105 of the operation log table 1100. Details of a feedback event type field 1509 are the information listed in the feedback event type field 1006 of the feedback operation log table 1000. Details of a comment detail field 1510 are the information listed in the comment detail field 1007 of the feedback operation log table 1000. Details of a position information field 1008 are the information listed in the position information field 1008 of the feedback operation log table 1000. Details of a registration button press-down time field 1512 are the information listed in the registration button press-down time field 1009 of the feedback operation log table 1000. Details of a changed URL field 1513 are the information listed in the communicated URL field 1206 of the communication log table 1200.

A window for assessment result 1600 shown in FIG. 16 consisting of above details and generated based on the tabulated result table 1500 shows a series of the operations performed between the assessment-start instruction operated by the user and the assessment-end instruction operated by the user, i.e. during one session, as a block of the assessment results. The window for assessment result 1600 is generated based on the assessment information having the same feedback event session ID.

In the window for assessment result 1600, the information relating to the usability assessments input by the user is displayed in the order of the transitions of windows displayed on the web browser of the terminal for assessor 10 due to operational inputs when the user browses the contents.

A transition order field 1601 displays IDs given in the order of the transitions of the windows. An operation date-time field 1602 lists details of the event generation date-time field 1505 of the tabulated result table 1500. A URL field 1603 lists details of the current URL field 1504 of the tabulated result table 1500. For example, in the tabulated result table 1500 of FIG. 15, for lines between a line which has “c0” for the log ID field 1501 with a value for the current URL field 1504 and a line which has “c1” for the log ID field 1501 with the next value for the current URL field 1504, it is decided that these lines relate to the content corresponding to a value “hoge1.html” of the current URL field 1504 of the line which has “c0” for the log ID field 1501.

A window field 1604 displays images generated based on the files corresponding to the file names listed as details of the event generation time window field 1506 of the tabulated result table 1500. An arrangement for displaying a mark 1610 listed and superimposed on the window is the same as the case of the mark 1410 described in FIG. 14. An operation target or assessment field 1605 lists information based on the information listed in the operation object field 1507 or the feedback event type field 1509 of the tabulated result table 1500. An operation or comment field 1606 lists information based on the information listed in the event field 1508 or the comment detail field 1510 of the tabulated result table 1500.

In accordance with the window for assessment result 1600 of FIG. 16 consisting of above details, the assessor of the usability can easily understand what operation has been performed for which window by the user. The assessor can directly know the URL of the content which is a target of the assessment. Also, from the position of the mark 1610 superimposed and displayed on the hard copy data, the assessor can easily understand what position on the window displayed on the web browser is assessed by the user. Also, from the design given to the mark 1610, the assessor can intuitively understand what type of the assessment has been performed. Further, since the assessments performed by the user are displayed in the order of the transitions of the windows, from the windows displayed in the vicinity, the assessor can easily understand what type of the assessment has been performed by the user at what stage of what operation.

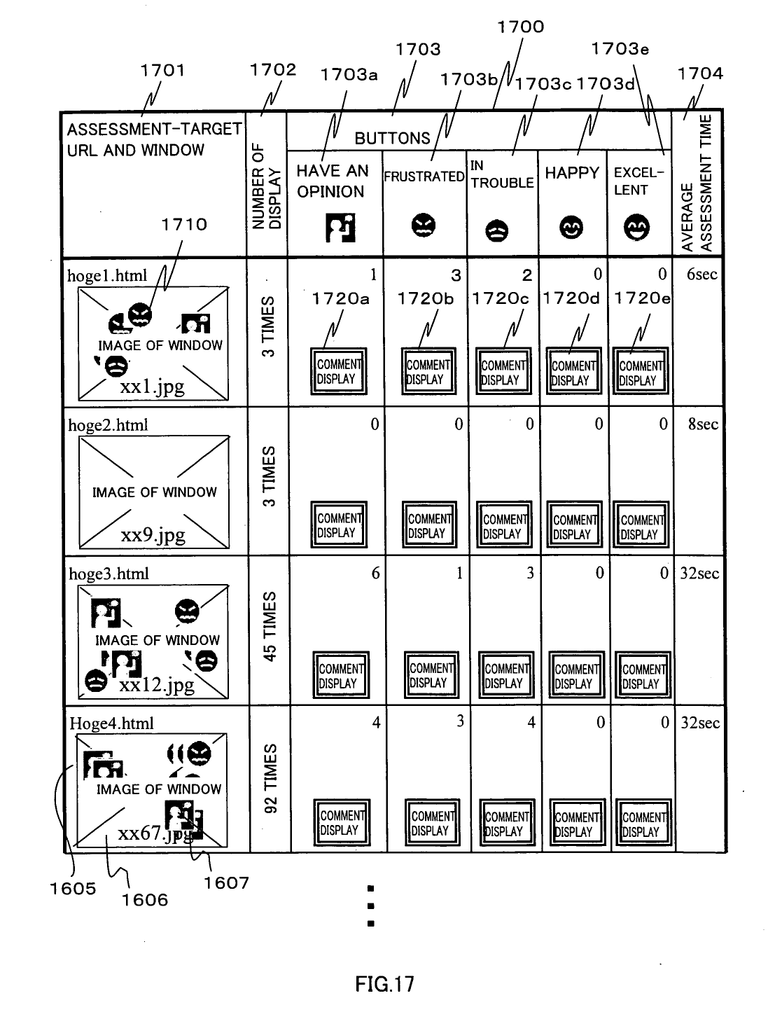

FIG. 17 is another example of the window for assessment result generated with the use of the tabulated result table 1500. The window for assessment result 1700 lists tabulated results of the assessment for each URL of the window which was a target of the usability assessment. An assessment-target URL and window field 1701 displays images generated based on the files corresponding to the file names listed as details of the event generation time window field 1506 of the tabulated result-table 1500. This field 1701 also lists the above URLs and file names. An arrangement for displaying a mark 1710 is the same as the case of FIG. 14. These images display the marks 1410 corresponding to all the assessments listed in the tabulated result table 1500 which are performed to the windows of the assessment-target URLs. A number of display field 1702 lists the numbers of display of the windows listed in the assessment-target URL and window field 1701, which are understood from the tabulated result table 1500.

A button field displays the numbers of the assessments performed using each of the buttons enabling the user to provide their impression 412a to 412d and the comment-only input button 413 for the windows listed in the assessment-target URL and window field 1701. A comment display buttons 1720a to 1720e are buttons for displaying windows which list the comments input in the comment input field 414 or the comment input field 511 (comment list window 1800). An average assessment time field 1704 displays average times required to perform the assessments. The average times are obtained as average values of times between the clock times listed in the event generation time field 1505 and the clock times listed in the registration button press-down time field 1512.

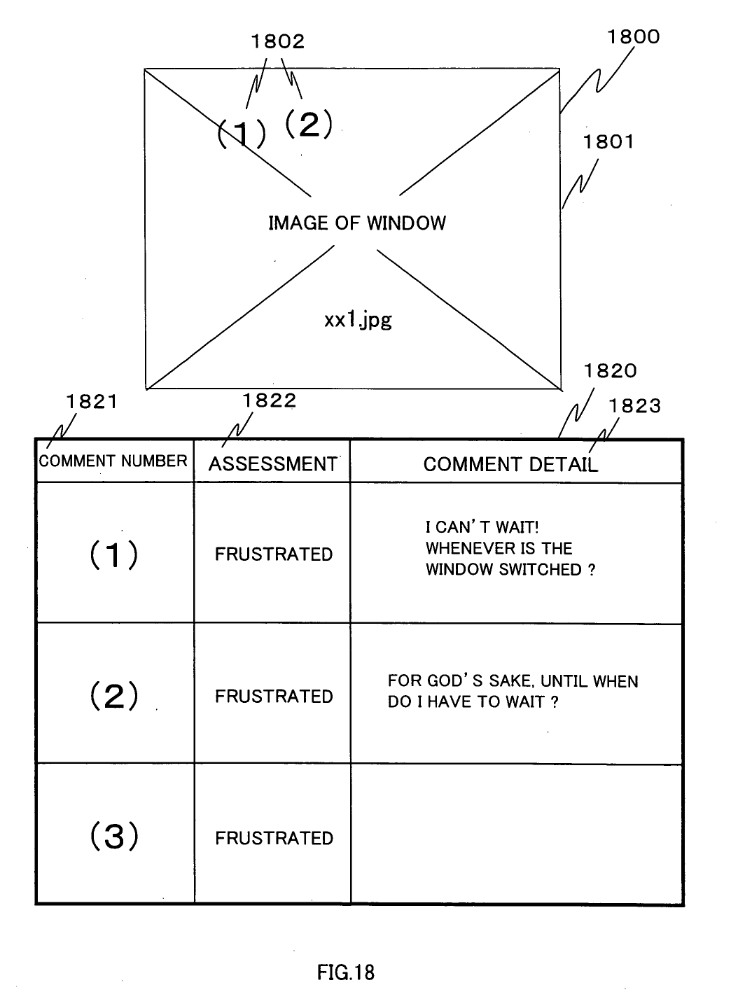

FIG. 18 is a comment list window 1800 displayed in the case of clicking the comment display button 1720b of FIG. 17. An upper section of the comment list window 1800 displays an image 1801 displayed in the assessment-target URL and window field 1701 of FIG. 17. The image 1801 is superimposed with marks 1802 for filling numbers at positions where a button indicating “feel frustrated” is set. The numbers correspond to numbers displayed in a comment number field 1821 of a comment list 1820 which is displayed in a lower section.

The comment number field 1821 of the comment list 1820 in a lower section displays comment numbers which are IDs for identifying comments input when the assessments are performed using the button 1703b of FIG. 17 indicating “feel frustrated”. An assessment field 1822 displays details listed in the feedback event type field 1509 of the tabulated result table 1500 of FIG. 15. A comment detail field 1823 displays details listed in the comment detail field 1510 of the tabulated result table 1500 of FIG. 15. In the case that the comment number is (3), the comment detail field 1823 is blank, and this means that the comment has not been input. Also, in the case that the comment number is (3), the corresponding mark does not exist on the image 1801, and this means that the user has not specified a position in the window when performing the assessment.

In accordance with the window for assessment result 1700 of FIG. 17 consisting of above details, the assessor of the usability can easily checks the assessment result for each window. Also, by referring to the assessment-target URL and window field 1701, the assessor can easily understand what position on the window is assessed. The assessor can easily check the number of the assessments performed using each of the buttons enabling the user to provide their impression 412a to 412d and the comment-only input button 413. The assessor can also easily understand the average assessment time for each window. By clicking the comment display buttons 1720a to 1720e, details of the comments can be checked. Since the window for displaying the details of the comments are displayed as a separate window, a window structure of the window for assessment result 1700 can be simplified, and the user can easily obtain desired information from the assessment results.

The above described usability assessment system separately obtains the assessment information such as the feedback operation logs, the operation logs and the communication logs, and correlates information included in the assessment information in chronological order based on the date-time information included in each log. In this way, as shown in FIG. 14, FIG. 16, FIG. 17, FIG. 18 and others, the usability assessment information can be provided in various and flexible expression forms. Also, from these pieces of the information, subjective usability assessments from the user can be known accurately, and the assessor of the usability can perform usability assessments to the contents efficiently and reliably. In the present invention, the assessment information such as the feedback operation logs, the operation logs and the communication logs is obtained by the functions of the plug-in program running on the client side. Therefore, accurate usability assessments can be performed, even to the dynamic contents constructed to be operated only on the client side.

By the way, above descriptions of the embodiments are intended to facilitate understanding of the present invention and are not intended to limit the present invention. The present invention may be modified and altered without departing from the spirit of the present invention and the present invention includes equivalents thereof.

For example, the functions of the terminal for assessor 10 and the server for assessments 30 of the above embodiments can be achieved with the use of one computer. Although, in the above described embodiments, the server for assessments 30 has functions for centralizing the assessment information and displaying the assessment results, these functions can be provided in the terminal for assessor 10 and the web server 20. Also, the databases 11, 13 are not limited to the case of being provided in the above locations.

The contents to be assessed are not limited to the contents provided by the web server 20 described in the above embodiments, and the present invention can be applied to the case of performing the usability assessments to contents provided by various application systems operated with the use of client/server systems and peer-to-peer systems, for example. Also, the contents to be the targets of the usability assessments are not limited to the windows, and the present invention can be applied to the case when web applications are targets.

Although, in the above described embodiments, the URLs are used as the information for identifying the contents, the contents can be identified by a window name given to each of the contents. In this case, correspondences between the URLs and the window names must be managed.

Although, in the above described embodiments, four buttons enabling the user to provide their impression 412a to 412d are provided, the expression may be made by numeric values corresponding to levels. Also, the usability assessments may be performed effectively by preparing user interfaces with aspects preferred for assessing characteristics of the contents, such as buttons for assessing usefulness/unusefulness. Also, the present invention can be extensively applied to not only the case of performing the usability assessments of static aspects of the contents, such as designs of windows, but also the case of performing the usability assessments of dynamic aspects of the contents, such as response times.

1. An information processing system for evaluating usability to content, comprising:
a display controller module for displaying a window for the content on a display device depending on operations to an input device;
a feedback event handler module for obtaining feedback operation logs including assessment information for the window and date-time information when the assessment information is input;
an operation event information acquisition module for obtaining operation logs including operation information for the input device and date-time information when the operation is input;
a content event information acquisition module for obtaining communication logs including date-time information when the window is displayed and information for identifying the window; and
an assessment information generator module for correlating information included in at least two of the feedback operation logs, the operation logs and the communication logs in chronological order based on the date-time information included in each log, and thus generating usability assessment information to the content.

2. An information processing system for evaluating usability to content, comprising:
a first information processing apparatus; and
a second information processing apparatus,
wherein the first information processing apparatus and the second information processing apparatus can communicate with each other via network,
wherein the first information processing apparatus includes:
a display controller module for displaying a window for the content on a display device depending on operations to an input device;
a feedback event handler module for obtaining feedback operation logs including assessment information for the window and date-time information when the assessment information is input;
an operation event information acquisition module for obtaining operation logs including operation information for the input device and date-time information when the operation is input;
a content event information acquisition module for obtaining communication logs including date-time information when the window is displayed and information for identifying the window; and
a transmission module for transmitting the feedback operation logs, the operation logs and the communication logs to the second information processing apparatus, and
wherein the second information processing apparatus includes:
a reception module for receiving the feedback operation logs, the operation logs and the communication logs from the first information processing apparatus; and
an assessment information generator module for correlating information included in at least two of the feedback operation logs, the operation logs and the communication logs in chronological order based on the date-time information included in each log, and thus generating usability assessment information to the content.

3. An information processing apparatus for evaluating usability to content, the information processing apparatus being able to communicate with another information processing apparatus via network, comprising:
a display controller module for displaying a window based on the content on a display device depending on operations to an input device;
a feedback event handler module for obtaining feedback operation logs including assessment information for the window and date-time information when the assessment information is input;
an operation event information acquisition module for obtaining operation logs including operation information for the input device and date-time information when the operation is input;
a content event information acquisition module for obtaining communication logs including date-time information when the window is displayed and information for identifying the window; and
a data transmission module for transmitting the feedback operation logs, the operation logs and the communication logs to the another information processing apparatus.

4. The information processing apparatus of claim 3, wherein
the display controller module displays a window for the content on the display device depending on operations to the input device, along with user interfaces for inputting assessment information for the window, wherein
the user interfaces include multiple buttons corresponding to types of assessments to the content, and wherein
the assessment information for the window in the feedback operation logs includes the types of the assessments specified by the buttons.

5. The information processing apparatus of claim 3, wherein
the display controller module displays a window for the content on the display device depending on operations to the input device, along with user interfaces for inputting assessment information for the window, wherein
the user interfaces include a user interface for inputting a comment to the content, and wherein
the assessment information for the window in the feedback operation logs includes comments input by the user interface for inputting the comment.

6. The information processing apparatus of claim 3, wherein
the display controller module obtains data of a hardcopy of the window to be evaluated, and wherein
the assessment information for the window includes the data of the hard copy.

7. The information processing apparatus of claim 3, wherein
the display controller module displays a window for the content on the display device depending on operations to the input device, along with user interfaces for inputting assessment information for the window, wherein
the user interfaces include a user interface for specifying a position to be evaluated in the window, and wherein
the assessment information for the window in the feedback operation logs includes position information specified by the user interface for specifying a position to be evaluated.

8. The information processing apparatus of claim 3, wherein
the operation information to the input device in the operation logs includes information for identifying an object to be operated in the window or information for identifying a type of the operation.

9. The information processing apparatus of claim 3, wherein
the information for identifying the window in the communication logs includes at least one of information indicating location of a window displayed before switching to new window and information indicating location of the new window.

10. The information processing apparatus of claim 3, further comprising:
a communication interface for connecting with the Internet, wherein
the content is content provided by a web server on the Internet, and wherein
the window displayed on the display device by the display controller module is a web page obtained by accessing to the web server.

11. The information processing apparatus of claim 10, wherein
the display controller module displays the web page with a web browser, and wherein
the web browser includes functions for displaying a window for the content depending on operations to the input device, along with user interfaces for inputting assessment information for the window, as plug-in programs.

12. An information processing apparatus for evaluating usability to content, the information processing apparatus being able to communicate with another information processing apparatus via network, comprising:
a reception module for receiving, from the another information processing apparatus, feedback operation logs including assessment information for a window for the content which is a window displayed on the another information processing apparatus and date-time information when the assessment information is input to the another information processing apparatus, the operation logs including operation information to the another information processing apparatus and date-time information when the operation is input to the another information processing apparatus, and the communication logs including date-time information when the window is displayed on the another information processing apparatus and information for identifying the window; and
an assessment information generator module for correlating information included in at least two of the feedback operation logs, the operation logs and the communication logs in chronological order based on the date-time information included in each log, and thus generating usability assessment information to the content.

13. An information processing apparatus of claim 12, wherein
the assessment information for the window includes hardcopy data of the window to be evaluated, and wherein
the usability assessment information for the content includes information correlating the date-time information with a window generated based on the hardcopy data which is the window displayed on the display device at clock time corresponding to the date-time information in chronological order.

14. The information processing apparatus of claim 12, wherein
the assessment information for the window includes hardcopy data of the window to be evaluated and information indicating a position in the window to be evaluated, wherein
the usability assessment information for the content includes information correlating the date-time information with a window generated based on the hardcopy data which is the window displayed on the another information processing apparatus at clock time corresponding to the date-time information in chronological order, and wherein
the window generated based on the hardcopy data includes a mark at a position corresponding to the information indicating the position.

15. The information processing apparatus of claim 12, wherein
the assessment information for the window in the feedback operation logs includes a type of the assessment for the content specified to the another information processing apparatus, and wherein
the usability assessment information for the content includes information correlating the date-time information with information indicating the type of the assessment in chronological order.

16. The information processing apparatus of claim 12, wherein
the assessment information for the window in the feedback operation logs includes a comment to the content, and wherein
the usability assessment information for the content includes information correlating the date-time information with the comment in chronological order.

17. The information processing apparatus of claim 12, wherein
the assessment information for the window in the feedback operation logs includes hardcopy data of the window to be evaluated and a type of the assessment for the content specified to the another information processing apparatus, and wherein
the usability assessment information for the content includes a window generated based on the hardcopy data and at least one of the number of appearances of the window, the number of selections for each of the windows and average time required to perform the assessment.

18. A method for evaluating usability to content, comprising the steps of:
a first information processing apparatus displaying a window for the content on a display device depending on operations to an input device;
the first information processing apparatus obtaining feedback operation logs including assessment information for the window and date-time information when the assessment information has been input;
the first information processing apparatus obtaining operation logs including operation information to the input device and date-time information when the operation has been input;
the first information processing apparatus obtaining communication logs including date-time information when the window has been displayed and information for identifying the window;
the first information processing apparatus sending to a second information processing apparatus the feedback operation logs, the operation logs and the communication logs;
the second information processing apparatus receiving from the first information processing apparatus the feedback operation logs, the operation logs and the communication logs; and
the second information processing apparatus correlating information included in at least two of the feedback operation logs, the operation logs and the communication logs in chronological order based on the date-time information included in each log, and thus generating usability assessment information for the content.

19. A program which can be read by an information processing apparatus for evaluating usability to content, wherein the information processing apparatus can communicate with another information processing apparatus via network, comprising:
a display controller module for displaying a window based on the content on a display device depending on operations to an input device;
a feedback event handler module for obtaining feedback operation logs including assessment information for the window and date-time information when the assessment information is input;
an operation event information acquisition module for obtaining operation logs including operation information for the input device and date-time information when the operation is input;
a content event information acquisition module for obtaining communication logs including date-time information when the window is displayed and information for identifying the window; and
a data transmission module for transmitting the feedback operation logs, the operation logs and the communication logs to the another information processing apparatus.

20. A program which can be read by an information processing apparatus for evaluating usability to content, wherein the information processing apparatus can communicate with another information processing apparatus via network, comprising:
a reception module for receiving, from the another information processing apparatus, feedback operation logs including assessment information for a window for the content which is a window displayed on the another information processing apparatus and date-time information when the assessment information is input to the another information processing apparatus, the operation logs including operation information to the another information processing apparatus and date-time information when the operation is input to the another information processing apparatus, and the communication logs including date-time information when the window is displayed on the another information processing apparatus and information for identifying the window; and
an assessment information generator module for correlating information included in at least two of the feedback operation logs, the operation logs and the communication logs in chronological order based on the date-time information included in each log, and thus generating usability assessment information to the content.
